(19) United States
(12) Patent Application Publication
(10) Pub. No.: US 2026/0253031 A1
(43) Pub. Date: Aug. 27, 2026

(54) AUTOGENERATION OF TASK DOCUMENTATION

(71) Applicant: INTERNATIONAL BUSINESS MACHINES CORPORATION, Armonk, NY (US)

(72) Inventors: David Mueller, Raleigh, NC (US); Steven Schwartz, Maple (CA); Simon Sungmin Lyu, West Vancouver (CA); Stacy Doyle, Whitby (CA)

(21) Appl. No.: 19/063,720

(22) Filed: Feb. 26, 2025

(51) Int. Cl. G06Q 10/10; G06F 40/166; G06N 20/00; G06Q 10/0631

(52) U.S. Cl. CPC G06Q 10/10; G06F 40/166; G06N 20/00; G06Q 10/06316

(57) ABSTRACT

A computer hardware system including an observer and an artificial intelligence (AI) agent is configured to perform the following. Event data corresponding to a particular predefined observed task having a plurality of discrete steps are collected within an observation matrix by the observer. The event data is structured by the observer into a plurality of task data clusters. The task data clusters are encoded by the observer with respective keys. The task data clusters with the respective keys are stored by the observer within a collection database. A task documentation file including textual descriptions respectively corresponding to the plurality of discrete steps of the predefined observed task is generated by a large language model within the AI agent and using the respective keys. The event data within a particular task data cluster corresponds to a discrete step of the particular predefined observed task.

### BACKGROUND

The present invention relates to autogeneration of task documentation, and more specifically, automatically collecting event data employing artificial intelligence (AI) to evaluate structured event data to automatically generate task documentation.

Modern business processes are supported by a complex network of task-based activities, and organizational continuity depends on maintaining a consistent knowledge base that details these tasks in a standardized way. To avoid even the most minor tasks being subjected to a single point of failure in the loss of any individual worker, these tasks should be documented within the enterprise and this documentation must be maintained to reflect the many constant changes within the enterprise ecosystem.

### SUMMARY

A method is performed by a computer hardware system including an observer and an artificial intelligence (AI) agent. Event data corresponding to a particular predefined observed task having a plurality of discrete steps are collected within an observation matrix by the observer. The event data is structured by the observer into a plurality of task data clusters Task data clusters are encoded by the observer with respective keys. The task data clusters with the respective keys are stored by the observer within a collection database. A task documentation file, including textual descriptions respectively corresponding to the plurality of discrete steps of the predefined observed task, is generated by a large language model within the AI agent and using the respective keys. The event data within a particular task data cluster corresponds to a discrete step of the particular predefined observed task.

Additionally, the methodology includes the event data being comprised of a plurality of discrete portions, and the clustering is based upon timestamps associated with individual ones of the discrete portions. Also, the plurality of discrete steps of the predefined observed task are ordered using the timestamps, and the textual descriptions within the task documentation file are ordered based upon an ordering of the plurality of discrete steps of the predefined observed task. The observation matrix defines a plurality of devices configured to capture the event data corresponding to the particular predefined observed task. Edits for the task documentation file are received, and the large language model is trained using the received edits. Each of the respective keys is associated with a prompt, and the task documentation file is generated using a large language model transformer that employs the prompts as input into a large language model to generate the textual descriptions.

A computer hardware system includes an observer and an artificial intelligence (AI) agent. The computer hardware system also includes a hardware processor configured to initiate the following operations. Event data corresponding to a particular predefined observed task having a plurality of discrete steps are collected within an observation matrix by the observer. The event data is structured by the observer into a plurality of task data clusters Task data clusters are encoded by the observer with respective keys. The task data clusters with the respective keys are stored by the observer within a collection database. A task documentation file, including textual descriptions respectively corresponding to the plurality of discrete steps of the predefined observed task, is generated by a large language model within the AI agent and using the respective keys. The event data within a particular task data cluster corresponds to a discrete step of the particular predefined observed task.

Additionally, the system includes the event data being comprised of a plurality of discrete portions, and the clustering is based upon timestamps associated with individual ones of the discrete portions. Also, the plurality of discrete steps of the predefined observed task are ordered using the timestamps, and the textual descriptions within the task documentation file are ordered based upon an ordering of the plurality of discrete steps of the predefined observed task. The observation matrix defines a plurality of devices configured to capture the event data corresponding to the particular predefined observed task. Edits for the task documentation file are received, and the large language model is trained using the received edits. Each of the respective keys is associated with a prompt, and the task documentation file is generated using a large language model transformer that employs the prompts as input into a large language model to generate the textual descriptions.

A computer program product comprises a computer readable storage medium having stored therein program code for evaluating a proposed modification to a current computer-implemented process. The program code, which when executed by a computer hardware system including an observer and an artificial intelligence (AI) agent, causes the computer hardware system to perform the following. Event data corresponding to a particular predefined observed task having a plurality of discrete steps are collected within an observation matrix by the observer. The event data is structured by the observer into a plurality of task data clusters Task data clusters are encoded by the observer with respective keys. The task data clusters with the respective keys are stored by the observer within a collection database. A task documentation file, including textual descriptions respectively corresponding to the plurality of discrete steps of the predefined observed task, is generated by a large language model within the AI agent and using the respective keys. The event data within a particular task data cluster corresponds to a discrete step of the particular predefined observed task.

Additionally, the compute program product includes the event data being comprised of a plurality of discrete portions, and the clustering is based upon timestamps associated with individual ones of the discrete portions. Also, the plurality of discrete steps of the predefined observed task are ordered using the timestamps, and the textual descriptions within the task documentation file are ordered based upon an ordering of the plurality of discrete steps of the predefined observed task. The observation matrix defines a plurality of devices configured to capture the event data corresponding to the particular predefined observed task. Edits for the task documentation file are received, and the large language model is trained using the received edits. Each of the respective keys is associated with a prompt, and the task documentation file is generated using a large language model transformer that employs the prompts as input into a large language model to generate the textual descriptions.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is a block diagram illustrating an example architecture of a task documentation autogeneration system according to an embodiment of the present invention.

FIG. 2 is a block diagram illustrating a methodology using the architecture of FIG. 1 according to an embodiment of the present invention.

FIG. 3 is a block diagram illustrating an example of a computer environment for implementing portions of the methodology of FIG. 2.

### DETAILED DESCRIPTION

Although most enterprises depend on a vast and diverse collection of tasks, the present disclosure leverages the recognition that there is considerable overlap among a lesser number of sets that these tasks comprise—both from an operational and a semantic perspective. For example, though the content and purpose of filing a certain report might differ considerably from those of a different report, the task of “filing a report” consists of similar concepts, actions, events, and tools, such that they can be described within a common lexicon or corpus.

Additionally, each of the tasks are performed using tools, such as a runtime or operating system, that produce event data describing the work these tools perform. The present disclosure leverages process mining technologies to observe this event data to discover and optimize the granular tasks that make up organizational objectives. A similar course of discovery can be the source material to document these processes by structuring and classifying event data from multiple sources and modalities and correlating the results to generate natural language strings that describe the composite tasks that comprise the event data. As will be subsequently described, the disclosed task documentation autogeneration system includes an observer 130 that gathers and structures event data from a plurality of sources and modalities that are associated with a given task and an AI agent 150 that uses this structured data to generate written documentation for the task.

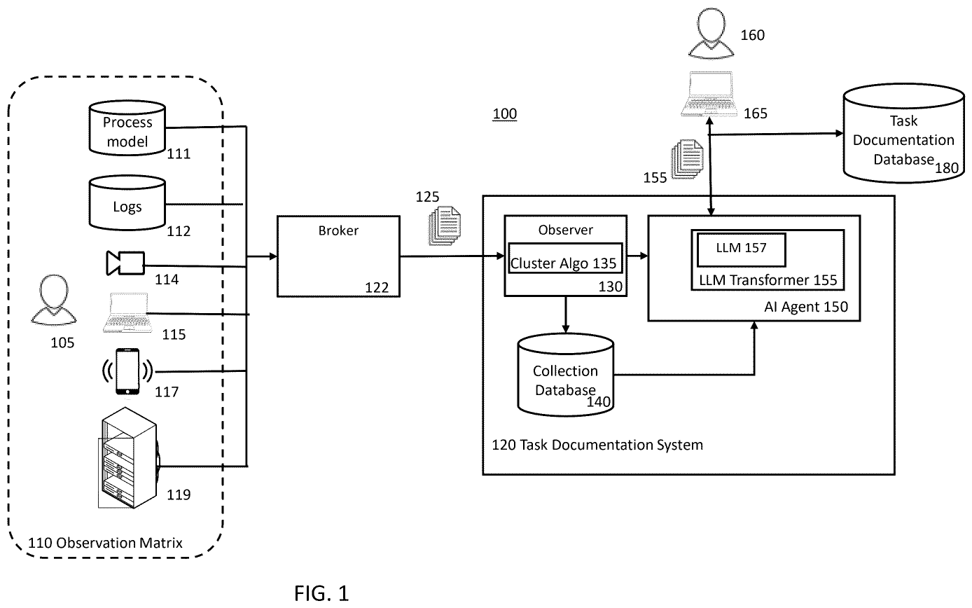

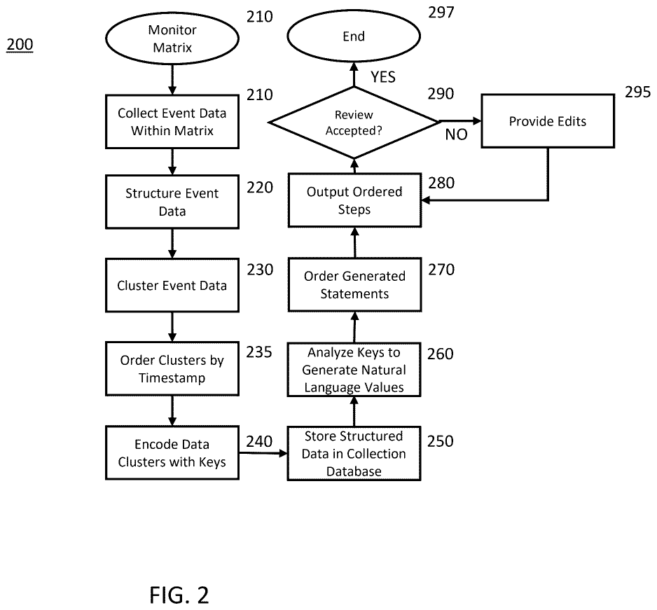

Referring to FIGS. 1 and 2, an exemplary task documentation autogeneration system 100 and process 200 of using the same are illustrated. In general, the methodology 200 employs a task documentation system 120 having an observer 130 and an artificial intelligence (AI) agent 150. The task documentation system 120 is configured to perform the following operations. Event data 125 corresponding to a particular predefined observed task by a user 105 having a plurality of discrete steps are collected within an observation matrix 110 by the observer 130. The event data 125 is structured by the observer 130 into a plurality of task data clusters. The task data clusters are encoded by the observer 130 with respective keys. The task data clusters with the respective keys are stored by the observer 130 within a collection database 140. A task documentation file 155 including textual descriptions respectively corresponding to the plurality of discrete steps of the predefined observed task is generated by a large language model 157 within the AI agent 150 and using the respective keys. The event data 125 within a particular task data cluster corresponds to a discrete step of the particular predefined observed task.

Additionally, the event data 125 can be comprised of a plurality of discrete portions, and the clustering is based upon timestamps associated with individual ones of the discrete portions. Also, the plurality of discrete steps of the predefined observed task are ordered using the timestamps, and the textual descriptions within the task documentation file 155 are ordered based upon an ordering of the plurality of discrete steps of the predefined observed task. The observation matrix 110 defines a plurality of devices 111, 112, 114, 115, 117, 119 configured to capture the event data 125 corresponding to the particular predefined observed task. Edits for the task documentation file 155 are received from another user 160 using a computer device 165, and the large language model 157 is trained using the received edits. Each of the respective keys is associated with a prompt, and the task documentation file 155 is generated using a large language model transformer 154 that employs the prompts as input into a large language model 157 to generate the textual descriptions.

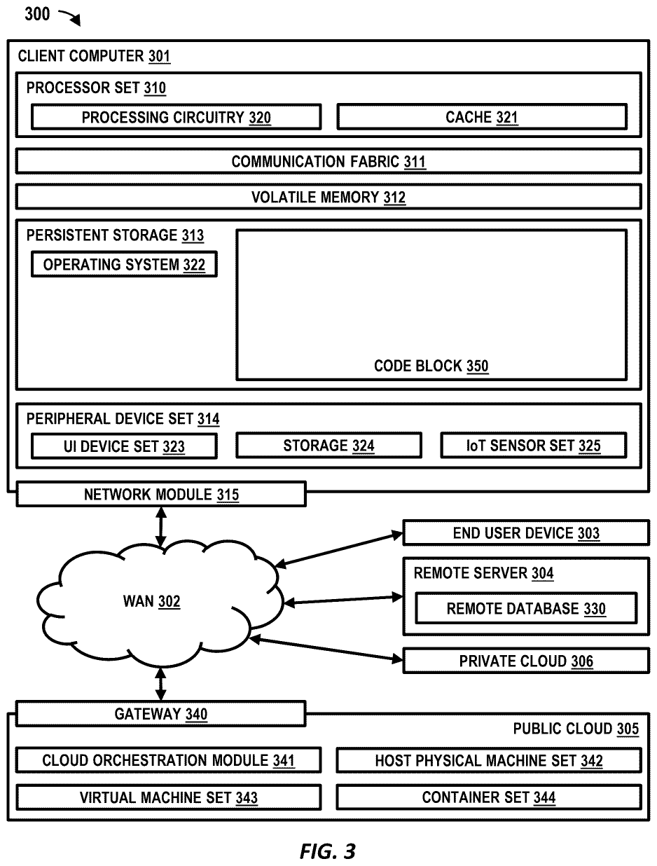

Although not limited in this manner, the task documentation system 120 includes a number of components including the observer 130, collection database 140, and AI agent 150. Although these components are illustrated as being separate components, one or more of these components can be integrated together and/or provided as software as a service, as further described with regard to FIG. 3. Additionally, while the task documentation database 180 is illustrated as being separate from the task documentation system 120, the task documentation database 180 can be included, in whole or in part, within the task documentation system 120 and/or may be combined with the collection database 140.

The observation matrix 110 defines (bounds) one or more devices 111-119 that automatically capture aspects of the observed tasks as event data 125. The observation matrix 110 can be predefined for a particular task being observed or can be user-selected. The devices 111-119 within the observation matrix 110 are not limited to any particular type. However, each device 111-119 is configured to provide event data 125 that describes some aspect of the observed task and/or a context in which the observed task is performed. Examples of the devices include process models 111, logs 112, video capture devices 114, personal computing devices such as a laptop 115 or mobile device 117, and servers 119. The event data 125 can be both unstructured or structured data as well as discrete data (e.g., the configuration of a server) or a data stream (e.g., the feed from a video camera).

The observer 130 is configured to gather and structure event data 125 or streams of event data 125, as input, within a bounded area (i.e., observation matrix 110) for a given observed task. This event data 125 can be gathered directly from various endpoints and/or aggregated by a message broker 122. Examples of event data 125 include event strings from process logs 112, process mining data extracted from screen recordings, computer-vision enabled descriptions of physical actions from video capture devices 114, higher order business process models 111 and/or data from computer devices such as laptops 115, mobile devices 117, and servers 119. The collected event data 125 can also include static data such as system details from the observation matrix 110 in which the task in question is being carried out, such as OS and software levels. The event data 125 can also be obtained by query or inferred from metadata associated with the event data 125 being collected.

As an example, the task of downloading a file and saving it to another location occurs within the matrix of a computer network, which can include a local laptop and one or more remote servers. Each step in this task creates specific data records within the matrix, including log files, API calls, and screen-recordings. Furthermore, static data about the matrix itself, such as software versions and operating systems is also available as contextual data. These data records and static data are examples of information the observer 130 can gather and timestamp to create a data profile of the task.

Another example is a scenario in which the task to be performed involves an administrator configuring an application running in a Kubernetes cluster is to integrate with a new database. During the execution of this task, events are created on the administrator's computer device and can include updates to database credentials. Events can also be created on the cluster, such as starting the application pod. Moreover, events can be created on the database itself, such as establishing a connection to the application. Additionally, each of these events include metadata about how and when the event occurs. The data available in these different devices and capable of being captured by the observer 130 can be richer and more varied than what could be captured in screen recordings alone.

The observer 130 is also configured to structure the event data 125 using various different approaches. The structuring of the event data 125 can include clustering the event data 125, using one or more pre-trained clustering algorithms 135, into a plurality of task data clusters respectively corresponding to a discrete step of the observed task. These approaches to structuring the event data 125 can include by selection, by time, by segmentation, and by type. In a “by selection” approach, the observer 130 can be configured to collect only a subset of the total event data 125 that is available. For example, if the target task is downloading a file from a browser, ads in the browser or icons on the desktop may be ignored and not collected. As another example, if the target tasks is to change a lightbulb within a device, an insect captured by a video capture device 114 may be ignored and that data not collected.

In a ‘by time” approach, the observer 130 can be configured to recognize timestamp information in the event data 125 being ingested and can also be configured to add timestamps to the event data 125, as needed. In a “by segmentation approach,” the observer 130 can be configured to recognize a natural segmentation of the event data 125—for example, by line breaks/numbering in logs or natural language statements in computer vision output.

In a “by type” approach, the observer 130 can be configured to employ topic modeling to associate event data 125 with operations and to cluster data from event streams into groups according to the associated tasks/operations/functions. The observer 130 can structure these segments as distinct keys to which the AI agent 150 can assign a value (e.g., a natural language statement of a task step or part thereof). Examples of a key-value structure is JSON or a similar format.

The observer 130 can be configured to logically structure the event data 125 being collected by clustering events (event data) along axes of time and functional area. These task data clusters can be persisted to a collection database 140 in key-value arrangement, with the values to be provided by the AI agent 150. The keys are paired with prompts that describe the desired output from the key. The prompts can used by language models 157 in the AI agent 150 to construct the natural language documentation 155.

After the event data 125 is clustered and structured into keys by the observer 130, the collection database 140 is configured to store the keys from the observer 130 and make those keys available to the AI agent 150.

The AI agent 150 is configured to compare the values of structured data fields to its training data (e.g., in a large language model (LLM) 157) to generate text strings that describe the actions/steps required to complete the particular predefined observed task. These text strings might be part of a preexisting corpus or they might be generated by a pre-trained transformer 155 such as GTP4 or BART. In this instance, during a data structuring phase, each key from the observer 130 would be paired with a prompt, whether text or an AI-generated soft prompt, that helps the LLM 157 describe the desired output, such as an imperative statement that instructs the reader to perform the action that generated the task data cluster represented by the key. The transformer 155 would then generate the desired text based on its training and fine tuning. An initial draft of the task documentation 155 can then be edited or augmented by a user 160, as needed.

The LLM 157 can be particularly trained for a domain encompassing the task. For example, for a system that is configured to document OpenShift configuration, the model 157 that the AI agent 150 uses can be fine-tuned with OpenShift log data. In so doing, when the AI agent 150 is presented with a key that is paired with a prompt from the observer 130, the AI agent 150 can leverage pretrained system knowledge to either match the key to an appropriate natural language string or part thereof in a preexisting corpus or to generate a new logical string that describes the necessary task step.

With specific reference to FIG. 2, an overview of the general process 200 for employing the task documentation autogeneration system 100 is disclosed. In 210, the devices 111-119 are configured to capture/record event data 125 within the target observation matrix 110. In 210, the observer 130 is configured to collect event data 125 from the devices 111-119. The collection of the event data 125 can be manually started or triggered automatically (e.g., a specified event in the context of the observation matrix 110. The observer 130 is also configured to gather system details (e.g., OS, runtime details, software levels) as part of the event data 125. The observer 130 can obtain this event data 125 by subscription, for example, to a message broker 122 that collects event data 125 from multiple sources (e.g., devices 111-119). The observer 130 can also be configured to ingest a specified subset of the total event data 125 that is available from the observation matrix 110 within a specified period of time.

In certain aspects, the observer 130 is configured to collection event data 125 from certain event types. The observer 130 can also be configured to collect event data 125 that conforms to a specified set of structured fields within the context of the task being observed. The types of event data 125 collected can include event data 125 from event logs, console logs, or other software processes, such as computer vision or process mining operations.

The collection of the event data 125 by the observer 130 is eventually stopped. This stopping of the collection of the event data 125 can be performed manually or responsive to a predetermined event (e.g., an event indicative of a complete of the task).

In 220, after collection of the input data has been completed, the observer 130 is configured to structure the event data 125. In 230, the event data 125 can be clustered. For example, in 235, the event data 125 can be clustered by particular steps along axes of time, e.g., by using timestamps associated with particular event data 125 and/or by functional area with pretrained clustering algorithms 135. These clustering algorithms 135 can include topic modeling such as Latent Dirichlet Allocation (LDA) and time series aware models like ST-DBSCAN (i.e., a spatio-temporal density-based clustering algorithm). The event data 125 can also be clustered into task data clusters by topic area in which each task data cluster represents a granular task action (i.e., a discrete step) that can be described in natural language.

In 240, the observer 130 is configured to encode the task data clusters with keys, which are then stored in the collection database 140 in 250. The task data clusters are encoded and persisted to the collection database 140 in a key-value arrangement in which each task data cluster is a key the values of which are to be provided to the AI agent 150. Additionally, each key can be paired with a prompt to be used by a downstream large language model (LLM) 157 in the AI agent 150 to generate descriptions of the task in step-by-step format. The prompts can be manually engineered text or AI-generated numerical “soft” prompts. Regarding of how generated, the prompts can be assigned to each task data cluster to aid the AI agent 150 in generating distinct task steps and sub-steps within a particular task step.

In 250, the observer 130 stores the complete set of structured data in a collection database 140. In 260, the AI agent 150 is configured to retrieve keys from the set of event data 125 previously-stored by the observer 130 and generate natural language values for each key within the set of event data 125. The AI agent 150, for example, can be configured to employ a LLM transformer 155, such as GTP-4 or BART, that can use the provided prompts for each key to generate text descriptions of the actions required to reproduce a given task step, as represented in the task data cluster/key. In 270, the AI agent 150 is also configured to order the generated text descriptions for each step into discrete ordered steps based upon the sequence identified by the observer 130.

In 280, the AI agent 150 is configured to output the ordered steps comprising the documented process as a task documentation file 155 to a computer device 165. The task documentation file 155 documents steps of the tasks, and these steps are retroactively engineered from event data 125 collected by the observer 130, and this task documentation file 155 can be machine-readable and/or human readable. In 290, the task documentation file 155 can be reviewed by a user 160. If the task documentation file 155 is accepted, the process can end at 297 in which the task documentation file 155 can be stored in a task documentation database 180 that is accessible by other users within the enterprise. Otherwise, the user 160 can provide edits to the task documentation file 155 in 295, which returns the process to 280 for the generation of a modified task documentation file 155 after the AI agent 150 has been trained using the edits.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

Referring to FIG. 3, computing environment 300 contains an example of an environment for the execution of at least some of the computer code involved in performing the inventive methods, such as code block 350 for implementing the operations of the task documentation system 120. Computing environment 300 includes, for example, computer 301, wide area network (WAN) 302, end user device (EUD) 303, remote server 304, public cloud 305, and private cloud 306. In certain aspects, computer 301 includes processor set 310 (including processing circuitry 320 and cache 321), communication fabric 311, volatile memory 312, persistent storage 313 (including operating system 322 and method code block 350), peripheral device set 314 (including user interface (UI), device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. However, to simplify this presentation of computing environment 300, detailed discussion is focused on a single computer, specifically computer 301. Computer 301 may or may not be located in a cloud, even though it is not shown in a cloud in FIG. 3 except to any extent as may be affirmatively indicated.

Processor set 310 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In certain computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in code block 350 in persistent storage 313.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible, hardware device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 311 is the signal conduction paths that allow the various components of computer 301 to communicate with each other. Typically, this communication fabric 311 is made of switches and electrically conductive paths, such as the switches and electrically conductive paths that make up busses, bridges, physical input/output ports and the like. Other types of signal communication paths may be used for the communication fabric 311, such as fiber optic communication paths and/or wireless communication paths.

Volatile memory 312 is any type of volatile memory now known or to be developed in the future. Examples include dynamic type random access memory (RAM) or static type RAM. Typically, the volatile memory 312 is characterized by random access, but this is not required unless affirmatively indicated. In computer 301, the volatile memory 312 is located in a single package and is internal to computer 301. In addition to alternatively, the volatile memory 312 may be distributed over multiple packages and/or located externally with respect to computer 301.

Persistent storage 313 is any form of non-volatile storage for computers that is now known or to be developed in the future. The non-volatility of the persistent storage 313 means that the stored data is maintained regardless of whether power is being supplied to computer 301 and/or directly to persistent storage 313. Persistent storage 313 may be a read only memory (ROM), but typically at least a portion of the persistent storage 313 allows writing of data, deletion of data and re-writing of data. Some familiar forms of persistent storage 313 include magnetic disks and solid state storage devices. Operating system 322 may take several forms, such as various known proprietary operating systems or open source Portable Operating System Interface type operating systems that employ a kernel. The code included in code block 350 typically includes at least some of the computer code involved in performing the inventive methods.

Peripheral device set 314 includes the set of peripheral devices for computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some aspects, storage 324 may take the form of a quantum computing storage device for storing data in the form of qubits. In aspects where computer 301 is required to have a large amount of storage (for example, where computer 301 locally stores and manages a large database) then this storage 324 may be provided by peripheral storage devices designed for storing very large amounts of data, such as a storage area network (SAN) that is shared by multiple, geographically distributed computers. Internet-of-Things (IoT) sensor set 325 is made up of sensors that can be used in IoT applications. For example, one sensor may be a thermometer and another sensor may be a motion detector.

Network module 315 is the collection of computer software, hardware, and firmware that allows computer 301 to communicate with other computers through a Wide Area Network (WAN) 302. Network module 315 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 315 are performed on the same physical hardware device. In other aspects (for example, aspects that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any Wide Area Network (for example, the internet) capable of communicating computer data over non-local distances by any technology for communicating computer data, now known or to be developed in the future. In some aspects, the WAN 302 ay be replaced and/or supplemented by local area networks (LANs) designed to communicate data between devices located in a local area, such as a Wi-Fi network. The WAN 302 and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In certain aspects, EUD 303 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304. As defined herein, the term “server” means a data processing system configured to share services with one or more other data processing systems.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other aspects, a private cloud 306 may be disconnected from the internet entirely (e.g., WAN 302) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 305 and private cloud 306 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if,” “when,” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

1. A computer-implemented method within a computer hardware system including an observer and an artificial intelligence (AI) agent, comprising:
collecting, within an observation matrix and by the observer, event data corresponding to a particular predefined observed task having a plurality of discrete steps, the event data being comprised of a plurality of discrete portions;
structuring, by the observer, the event data into a plurality of task data clusters by clustering the event data based upon timestamps associated with individual ones of the discrete portions;
encoding, by the observer, the task data clusters with respective keys;
storing, by the observer and within a collection database, the task data clusters with the respective keys;
fine-tuning a large language model with domain-specific log data corresponding to a domain encompassing the particular predefined observed task to generate a domain-specialized large language model; and
generating, by applying the domain-specialized large language model within the AI agent to the respective keys, a task documentation file including textual descriptions respectively corresponding to the plurality of discrete steps of the predefined observed task, the textual descriptions being ordered within the task documentation file according to the timestamps, wherein the event data within a particular task data cluster corresponds to a discrete step of the particular predefined observed task.

2. (canceled)

3. The method of claim 1, wherein the plurality of discrete steps of the predefined observed task are ordered using the timestamps.

4. The method of claim 3, wherein the textual descriptions within the task documentation file are ordered based upon an ordering of the plurality of discrete steps of the predefined observed task.

5. The method of claim 1, wherein the observation matrix defines a plurality of devices configured to capture the event data corresponding to the particular predefined observed task.

6. The method of claim 1, further comprising:
receiving edits for the task documentation file; and
training the domain-specialized large language model using the received edits.

7. The method of claim 1, wherein each of the respective keys is associated with a prompt, and wherein the task documentation file is generated using a large language model transformer that employs the prompts as input into the domain-specialized large language model to generate the textual descriptions.

8. A computer hardware system including an observer and an artificial intelligence (AI) agent, comprising:
a hardware processor configured to initiate the following executable operations:
collecting, within an observation matrix and by the observer, event data corresponding to a particular predefined observed task having a plurality of discrete steps, the event data being comprised of a plurality of discrete portions;
structuring, by the observer, the event data into a plurality of task data clusters by clustering the event data based upon timestamps associated with individual ones of the discrete portions;
encoding, by the observer, the task data clusters with respective keys;
storing, by the observer and within a collection database, the task data clusters with the respective keys;
fine-tuning a large language model with domain-specific log data corresponding to a domain encompassing the particular predefined observed task to generate a domain-specialized large language model; and
generating, by applying the domain-specialized large language model within the AI agent to the respective keys, a task documentation file including textual descriptions respectively corresponding to the plurality of discrete steps of the predefined observed task, the textual descriptions being ordered within the task documentation file according to the timestamps, wherein the event data within a particular task data cluster corresponds to a discrete step of the particular predefined observed task.

9. (canceled)

10. The system of claim 8, wherein the plurality of discrete steps of the predefined observed task are ordered using the timestamps.

11. The system of claim 10, wherein the textual descriptions within the task documentation file are ordered based upon an ordering of the plurality of discrete steps of the predefined observed task.

12. The system of claim 8, wherein the observation matrix defines a plurality of devices configured to capture the event data corresponding to the particular predefined observed task.

13. The system of claim 8, wherein the hardware processor is further configured to initiate the following executable operations:
receiving edits for the task documentation file; and
training the domain-specialized large language model using the received edits.

14. The system of claim 8, wherein each of the respective keys is associated with a prompt, and wherein the task documentation file is generated using a large language model transformer that employs the prompts as input into the domain-specialized large language model to generate the textual descriptions.

15. A computer program product, comprising:
a computer readable storage medium having stored therein program code,
the program code, which when executed by a computer hardware system including an observer and an artificial intelligence (AI) agent, causes the computer hardware system to perform:
collecting, within an observation matrix and by the observer, event data corresponding to a particular predefined observed task having a plurality of discrete steps, the event data being comprised of a plurality of discrete portions;
structuring, by the observer, the event data into a plurality of task data clusters by clustering the event data based upon timestamps associated with individual ones of the discrete portions;
encoding, by the observer, the task data clusters with respective keys;
storing, by the observer and within a collection database, the task data clusters with the respective keys;
fine-tuning a large language model with domain-specific log data corresponding to a domain encompassing the particular predefined observed task to generate a domain-specialized large language model; and
generating, by applying the domain-specialized large language model within the AI agent to the respective keys, a task documentation file including textual descriptions respectively corresponding to the plurality of discrete steps of the predefined observed task, the textual descriptions being ordered within the task documentation file according to the timestamps, wherein the event data within a particular task data cluster corresponds to a discrete step of the particular predefined observed task.

16. (canceled)

17. The computer program product of claim 15, wherein the plurality of discrete steps of the predefined observed task are ordered using the timestamps, and
the textual descriptions within the task documentation file are ordered based upon an ordering of the plurality of discrete steps of the predefined observed task.

18. The computer program product of claim 15, wherein the observation matrix defines a plurality of devices configured to capture the event data corresponding to the particular predefined observed task.

19. The computer program product of claim 15, wherein the program code further causes the computer hardware system to perform:
receiving edits for the task documentation file; and
training the domain-specialized large language model using the received edits.

20. The computer program product of claim 15, wherein
each of the respective keys is associated with a prompt, and
the task documentation file is generated using a large language model transformer that employs the prompts as input into the domain-specialized large language model to generate the textual descriptions.

21. The method of claim 1, wherein the clustering of the event data is performed using at least one of a Latent Dirichlet Allocation (LDA) topic-modeling algorithm and a spatio-temporal density-based (ST-DBSCAN) clustering algorithm.

22. The computer hardware system of claim 8, wherein the clustering of the event data is performed using at least one of a Latent Dirichlet Allocation (LDA) topic-modeling algorithm and a spatio-temporal density-based (ST-DBSCAN) clustering algorithm.

23. The computer program product of claim 15, wherein the clustering of the event data is performed using at least one of a Latent Dirichlet Allocation (LDA) topic-modeling algorithm and a spatio-temporal density-based (ST-DBSCAN) clustering algorithm.
